(19) United States
(12) Patent Application Publication
(10) Pub. No.: US 2025/0206342 A1
(43) Pub. Date: Jun. 26, 2025

(54) TRAJECTORY PLANNING BASED ON TREE SEARCH EXPANSION

(71) Applicant: Zoox, Inc., Foster City, CA (US)

(72) Inventors: Timothy Caldwell, Boulder, CO (US); Yan Chang, Sunnyvale, CA (US); Aaron Huang, San Francisco, CA (US); Gary Linscott, Seattle, WA (US); Peter Scott Schleede, El Dorado Hills, CA (US); Ke Sun, Foster City, CA (US); Xianan Huang, Foster City, CA (US)

(73) Assignee: Zoox, Inc., Foster City, CA (US)

(21) Appl. No.: 18/394,408

(22) Filed: Dec. 22, 2023

(51) Int. Cl. B60W 60/00

(52) U.S. Cl. CPC B60W 60/0011; B60W 2554/40

(57) ABSTRACT

Techniques for determining a vehicle trajectory that causes a vehicle to navigate in an environment relative to one or more objects are described herein. In some cases, the techniques described herein relate to selectively expanding a tree structure (e.g., a decision tree structure) to efficiently search for simulation data that can be used to evaluate vehicle control trajectories. The tree structure may include state nodes representing observed and/or predicted environment states, and action nodes representing candidate actions the vehicle may take. By selectively and incrementally expanding the tree structure, more optimal trajectories can be determined without exhaustively evaluating every possible outcome.

### BACKGROUND

Simulation models can be employed to predict an action for a variety of robotic devices. For instance, planning systems in autonomous and semi-autonomous vehicles determine actions for a vehicle to take in an operating environment. Actions for a vehicle may be determined based in part on avoiding objects present in the environment. For example, an action may be generated to yield to a pedestrian, to change a lane to avoid another vehicle in the road, or the like. Accurately predicting future object trajectories may be used to safely operate the vehicle in the vicinity of the object.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a flowchart diagram of an example process for evaluating a candidate trajectory by selectively expanding a tree structure.

FIG. 2 provides an operational example of a tree structure that may be used to perform trajectory planning for a vehicle.

FIG. 3 is a flowchart diagram of an example process for determining one or more cost measures for a trajectory using a tree structure.

FIG. 4 is a flowchart diagram of an example process for selective expansion of a tree structure up to an intermediate layer.

FIG. 5 is a flowchart diagram of an example process for expanding a tree structure at a layer deeper than an intermediate layer.

FIG. 6 depicts a block diagram of an example system for implementing the techniques described herein.

### DETAILED DESCRIPTION

This document describes techniques for determining a vehicle trajectory that causes a vehicle to navigate in an environment relative to one or more objects. In some cases, the techniques described herein relate to selectively expanding a tree structure (e.g., a decision tree structure) to efficiently search for data that can be used to evaluate vehicle control trajectories. The tree structure may include state nodes representing observed and/or predicted environment states, and action nodes representing candidate actions the vehicle may take. By selectively and incrementally expanding the tree using estimated state transition probabilities to focus on higher likelihood scenarios, more optimal trajectories can be determined without exhaustively evaluating every possible outcome. Additionally or alternatively, more computational resources may be dedicated to those nodes selected for expansion which may, in some instances, yield more accurate predictions and safer traversals. The selective expansion balances detailed exploration of relevant branches with purposeful pruning of redundant scenarios. This allows the vehicle to quickly plan safe and smooth trajectories through complex environments by concentrating computation on the most informative future scenarios. Accordingly, the techniques discussed herein may improve the safety of occupants of an autonomous vehicle that incorporates the techniques discussed herein. Moreover, the techniques may improve the efficiency of vehicle, such as an autonomous vehicle, in accomplishing a mission such as, for example, delivering passengers and/or cargo, surveying a region, or the like.

In some cases, the techniques described herein relate to a tree structure (e.g., a decision tree structure) with at least two types of nodes: state nodes and action nodes. An edge from a state node to an action node may represent that an action associated with the action node is performed (e.g., by a vehicle) while the environment of a vehicle corresponds to a state associated with the state node. An edge from an action node may represent that performing an action associated with the action node is predicted to result in a state associated with the state node. For example, the root node of the tree structure may represent the current state of a vehicle's environment. The root node may be connected to a set of action nodes, each corresponding to an action that may be performed by the vehicle in the current state. The action nodes may in turn be connected to predicted state nodes, each corresponding to a state of the environment that is predicted to result from performing an action. For example, the tree structure may represent that a first action may result to one of two potential predicted states (e.g., each with a computed probability of occurrence). Of course, this is one of several implementations and the disclosure is not meant to be so limiting. As an alternate or additional example, edges may be associated with actions such that a single type of node (e.g., state prediction or measurement) is used in the tree structure.

In some cases, the tree structure may be used to model sequential decision making for a vehicle navigating a dynamic environment. The root node of the tree structure may represent the vehicle's current environmental state (e.g., as determined based on the vehicle's sensor inputs). For example, the current environmental state may represent observed positions of other vehicles, pedestrians, traffic signals, and/or the like. In some cases, the action nodes connected to the root node capture possible actions the vehicle could perform in the current state. For example, action nodes may correspond to changing lanes, turning, accelerating, braking, and/or the like. Each action node may be connected to one or more predicted state nodes that model the potential outcomes of taking that action.

For example, if the vehicle is currently behind a slow lead vehicle, action nodes may correspond to maintaining current speed, braking, or changing lanes. The predicted state nodes may represent the different scenarios that may result from performing such actions. For example, a predicted state node may represent that, if the vehicle maintains current speed, the lead vehicle may remain close ahead. In some cases, the predicted state nodes resulting from a single action node may represent the uncertainty in potential outcomes. For example, predicted state nodes resulting from the action of changing lanes may represent that other vehicles in the target lane may accommodate and slow down or may fail to see the vehicle and not react. In some cases, each of those scenarios is associated with a corresponding predicted state node or nodes. In some cases, each predicted state node and/or each predicted scenario is associated with a computed probability of occurrence.

In some cases, the tree structure enables a system (e.g., the vehicle's computing device or a remote server that communicates with the vehicle) to simulate different action sequences and resulting states to generate an optimal trajectory for the validate. The tree structure may be expanded to determine predicted states in the future resulting from different sequences of actions. The predicted states may then be used to determine costs for different trajectories that are available to the vehicle. In some cases, based on those determined costs, an optimal trajectory for controlling the vehicle may be selected. In some cases, determining a trajectory for a vehicle based on simulations performed using expansions of a tree structure (e.g., a decision tree structure) may be performed using techniques that are described in U.S. patent application Ser. No. 18/084,419, entitled “Machine-Learned Cost Estimation in Tree Search Trajectory Generation for Vehicle Control” and filed on Dec. 19, 2022 and U.S. patent application Ser. No. 17/900,658, entitled “Trajectory Prediction Based on a Decision Tree” and filed on Aug. 31, 2022, both of which are incorporated by reference herein in their entireties and for all purposes.

In some cases, the techniques discussed herein may include a vehicle guidance system that generates a path for controlling an autonomous vehicle based at least in part on a tree search technique that alternately determines a candidate action and predicts a future state of the environment, dynamic object(s), and the autonomous vehicle responsive to the candidate action. The tree search may use a cost function to determine a cost associated with a predicted state and/or candidate action. In some examples, determining the cost using the cost function may include simulating future states of dynamic object(s) and/or the environment, which may be time consuming and computationally intensive. For example, to determine a first predicted state to further explore (to assess whether candidate action(s) to get to or from that state are feasible), cost(s) associated with a series of action(s) and/or predicted state(s) before and/or after that predicted state may be determined until an endpoint is reached, such as a horizon time along a route, to determine the cost associated with that first predicted state. This portion of the tree search may represent 40% or more of the latency of the tree search.

The tree search discussed herein may alternately determine a candidate action and a predicted state of the environment associated with (e.g., at least partially responsive to) the candidate action (and/or tracking from a vehicle state associated with the node toward the candidate action) at a future time step, another candidate action based on the predicted state of the environment, a second predicted state of the environment associated with the additional candidate action at a further future time step, and so on, up to a time horizon or a specified number of actions. A candidate action may indicate, for example, a trajectory for controlling motion of the vehicle, activating emitters of the vehicle (e.g., a turn signal, a headlight, a speaker), and/or the like. Each candidate action may be associated with a different action node and each predicted environment state may be associated with a prediction node of the tree.

As an initial operation, the tree search may determine, based at least in part on sensor data, the current state of an environment associated with the autonomous vehicle, which may include dynamic objects and/or static objects. This initial state may be associated with a root node. The root node may be a prediction node, in at least one example. The state of the environment may be indicated by a data structure associated with the root node/prediction node, in some examples. Using this initial state, the tree search may determine one or more candidate actions for exploration. A candidate action may comprise a coarse maneuver, such as “stay in same lane,” “lane change left,” “execute right turn,” “stop,” or the like; and/or fine instructions such as a curve that defines and/or is associated with a position, steering angle, steering rate, velocity, and/or acceleration for the vehicle controller to track. In some examples, determining the one or more candidate actions for exploration may comprise transmitting the initial environment state (or the state that is indicated by a particular prediction node of a branch that is being explored at predictions nodes deeper than the initial node) to the planning component of the vehicle and receiving the set of candidate actions from the planning component. The planning component may be a nominal planning component of the vehicle that generates one or more trajectories for controlling motion and/or operation of the vehicle in contrast to a contingent planning component that controls the vehicle during aberrant or emergency situations, although it is contemplated that a contingent planning component may additionally or alternatively provide generate candidate action(s) for use by the tree search. A tree search component may associate the one or more candidate actions of the set received from the planning component with action nodes. The actions may correspond to predetermined candidate trajectories available to the vehicle at a current and/or simulated future time.

In some cases, a state (e.g., the current state and/or a predicted future state) represented by a tree structure is associated with one or more state samples. A state sample may be a snapshot of an environment (e.g., a snapshot of the current environment or a snapshot of a predicted future environment) that contains sufficient data to perform a simulation with respect to the environment. For example, a first state may be associated with a first state sample that represents data (e.g., position, velocity, and/or acceleration) associated with a first object (e.g., a reactive entity, such as a vehicle), a second state sample that represents data associated with a second object (e.g., a nominal entity), and a third state sample that represents data associated with a third object (e.g., an inattentive entity).

Accordingly, in some cases, each action node may be downstream from a state node and may be downstream to one or more state nodes. Moreover, each state node may be associated with one or more state samples. In some cases, the number of state samples associated with a state node may represent a count of objects that are determined to be relevant to trajectory cost evaluation at the corresponding state.

In some cases, the techniques described herein relate to techniques for selective expansion of a tree structure corresponding to environment states and/or actions associated with a vehicle's environment. In some cases, the tree structure may be expanded to determine the range of potential future states that may result from the vehicle performing different action sequences. Accordingly, each expansion may capture predictions about how the environment is predicted to evolve over a timestep and under one or more different action selections. In some cases, tree structure can quickly grow very large as additional actions and states are explored. The computational costs associated with node expansion during tree search may be increased by the fact that, at every node, the set of actions may vary and the selected set of actions may be different across different sets of nodes. This may exponentially increase the computational costs associated with tree expansion. To manage the computational costs associated with tree expansion, the expansion may be focused on some tree branches (e.g., the most promising branches, the least redundant branches given branches that have already been expanded, etc.). Accordingly, in some cases, the tree structure may be selectively expanded by prioritizing exploration of higher quality and/or most informative branches, thus reducing the computational costs associated with tree search.

In some cases, to selectively expand a tree structure, an example system may perform at least one of the following operations: (i) initially expanding each node of the tree structure that corresponds to an action of a set of actions over a period of time, (ii) expanding each upper-level node from the first M layers of the tree structure, (iii) expanding a selected subset of “intermediate” nodes that are in layers M+1 to M+N, and (iv) expanding a selected subset of deeper-level nodes from a layer deeper than M+N+1 to the end until a terminating condition is reached (e.g., until a set of nodes associated with a threshold time period in the future period are expanded, until a threshold number of nodes and/or layers are expanded, and/or the like).

In some cases, the layer of a state node is determined based on the number of nodes between the state node and the root state node. For example, in some cases, a root state node is associated with a first layer, while the state nodes that depend from action nodes depending the root node are associated with a second layer. In some cases, a state node associated with an Ath layer depends directly from an action node that directly depends from a state node associated with an (A−1)th layer. In some cases, expansion of a state node includes expanding each action node that depends directly from that state node.

In some cases, selective expansion of an “intermediate” node may be performed based on an estimated cost associated with that intermediate node, for example an estimated cost determined using a trained machine-learned model. Example techniques for determining an estimated cost for a node of the tree structure are described in U.S. patent application Ser. No. 18/084,419, entitled “Machine Learned Cost Estimation in Tree Search Trajectory Generation for Vehicle Control,” and filed on Dec. 19, 2022, and U.S. patent application Ser. No. 18/392,114, entitled “Machine-Learned Candidate Action Selection in Tree Search,” and filed on Dec. 21, 2023, both of which are incorporated herein by reference in their entirety and for all purposes.

In some cases, the techniques described herein relate to initially generating the tree by expanding a node that is associated with one or more of a predefined set of actions. For example, an example system may expand each node that is associated with a predefined action (e.g., an action sequence with a sequence of actions) over a period of time. The period of time may be associated with a receding horizon, such that the time period may be updated as tree search progresses. Using a receding horizon may enable the tree search to balance between depth of exploration and computational capabilities in order to ensure that the system performs trajectory evaluation in a responsive and effective manner.

In some cases, a tree structure is used for trajectory generation at a particular time (e.g., during a particular trajectory generation iteration, where the frequency of iterations may be determined based on computational resources and/or based on configuration data associated with the planning system). In some cases, the particular time is also associated with a set of predefined actions, such as slowing the vehicle down at that particular time, turning the vehicle to the left at that particular time, turning the vehicle to the right at that particular time, and/or speeding the vehicle up at that particular time. A predefined action may provide a trajectory that the vehicle may pursue if trajectory generation process fails to detect a less costly trajectory. In other words, in some cases, the set of predefined actions may define a set of backup trajectories that the vehicle may pursue in the absence of detecting more optimal trajectories. The set of predefined actions may thus provide an upper-bound on the cost associated with an adopted trajectory, as in the absence of a less costly trajectory the system may adopt the lowest-cost trajectory associated with the set of predefined actions. Accordingly, the use of predefined actions and associated backup trajectories in a planning system may serve as a safeguard to ensure that the vehicle has a viable trajectory to follow even in scenarios where determining a more optimal trajectory is computationally infeasible and/or where real-world circumstances make it such that a more optimal trajectory is not available for the vehicle.

Accordingly, in some cases, selective expansion of a tree structure during the trajectory evaluation process starts with expanding a set of nodes that relate to a set of predefined actions (e.g., a set of predefined actions associated with the entirety of the tree structure, such as a set of predefined actions available at a current time). For example, if the set of predefined actions include turning the vehicle to the right, then a set of nodes of the tree structure that correspond to a right-turn action may be expanded. This expansion may be performed until a set of nodes that are associated with a time period in the future are expanded. The future time period may be determined based on a predefined amount of time (e.g., ten seconds into the future), based on a number of node expansions (e.g., a time period associated with expansion of one thousand nodes), based on a number of layer expansions (e.g., a time period associated with expansion of ten tree structure layers), based on an amount of computational resources used for node expansion (e.g., a time period associated with 10,000 processor-level instructions, and/or the like), and/or the like.

Accordingly, in some cases, an example system generates a tree structure by receiving a set of predefined actions associated with the corresponding planning iteration and then expands each node that is associated with at least one predefined action within a period of time (e.g., until the end of a receding planning horizon). For example, during a particular planning iteration, the system may receive or access a set of four predefined actions consisting of: accelerating forward at a predefined rate, decelerating forward at a predefined rate, turning left at a predefined rate, and turning right at a predefined rate. The system may then expand nodes corresponding to each such action over a five second future time period based on the system's configured receding horizon. This may result in initial expansion of portions of the tree structure associated with trajectories that perform the actions described above for five seconds. As another example, during a particular planning iteration, the system may receive or access a set of three predefined actions consisting of: maintaining current velocity straight ahead, braking at a moderate rate, and braking at maximum rate. The system may then expand nodes corresponding to each such action over a four second future period based on the system's configured receding horizon. This may result in initial expansion of parts of the tree associated with trajectories that perform the actions described above for four seconds.

In some cases, the techniques described herein relate to expanding one or more nodes (e.g., each node) associated with the first M layers of the tree structure, also referred to herein as top-level nodes of the tree structure. The value of M may be defined based on at least one of system configuration data, a number of computational resources available for tree search at the time associated with expanding the tree structure nodes, and/or the like. For example, in some cases, system configuration data may require expansion of the nodes associated with a first tree structure layer. The first layer may include all tree structure nodes that depend directly from action nodes that depend directly from the root node of the tree structure. In general, a Lth layer node of the tree structure may include all nodes of the tree structure that depend directly from an action node that depends directly from a state node in the (L−1)th layer of the tree structure, with the root node being associated with a first layer of the tree structure. In some cases, the value of M may be two.

In some cases, after expanding the nodes associated with the predefined set of actions over a future time period, an example system may continue selective expansion by expanding nodes in upper layers of the tree structure. For example, the system may expand all nodes in the first M layers of the tree structure. Such an expansion may comprise, for example, nodes representing switches between the various candidate actions at each layer in the tree structure. As a non-limiting example of which, a resultant trajectory may start by executing a stay in lane action but later switch to a change lanes action, thereby resulting in an optimal trajectory accounting for safety, progression of the vehicle to a desired destination, and comfort of occupants therein. Expanding such top-level nodes may enable the system to explore a wider variety of near-term planning options before focusing computational resources on evaluating longer-term trajectories associated with deeper layers. Determining an appropriate value for M may depend on balancing computational constraints with maximizing exploration of potentially high-quality trajectories associated with high initial costs but deeper overall costs. For example, if the value of M is small, then the system may fail to explore a trajectory that is associated with a high cost in its initial actions but has an overall low cost.

In some cases, one objective behind expansion of the first M layers of the tree structure may be to avoid selective expansion before reliable information about near-term costs are available. Expansion of the first M layers may provide data that is important for accurately and reliably evaluating the estimated costs associated with the intermediate layer nodes. In the absence of such expansion, the estimated costs computed for intermediate nodes may be determined based on inadequate near-term predictions and thus be less reliable. This may reduce effectiveness of the overall tree search and increase the information loss measure associated with selective tree expansion. In some cases, an intermediate layer may be selected from a set of layers that exclude a first and last layer of the tree structure.

In some cases, the techniques described herein relate to selective expansion of nodes associated with N intermediate layers of the tree structure based on estimated costs associated with those nodes. An intermediate node may be a node of the tree structure that depends from a layer whose layer number is within the range [M, M+N−1]. N may be the number of intermediate layers of the tree structure and may be determined based on at least one of: (i) a predefined number (e.g., as defined by system configuration data), or (ii) an amount of available computational resources. For example, N may be determined based on a number that is N+1 deeper than the total number of layers of the tree structure. In some cases, N may be at least two deeper than the total number of layers of the tree structure.

In some cases, the system expands a selected subset of the intermediate nodes of a tree structure based on estimated costs associated with those nodes. For example, in some cases, given N intermediate layers of the tree structure, the system starts with the layer among the N layers. For each node of the top intermediate layer, the system determines an estimated cost and then determines whether to select the node for expansion based on the determined estimated cost. For example, the system may expand T nodes in the top intermediate layer whose estimated costs are lower than other nodes in the same layer for expansion. As another example, the system may expand each node of the top intermediate layer whose estimated cost falls below an estimated cost threshold. As another example, the system may expand each node of the top intermediate layer whose estimated cost is among the lowest T estimated costs associated with the nodes of the same layer and whose estimated cost falls below an estimated cost threshold.

In some cases, after expanding a subset of the nodes associated with the top intermediate layer, the system determines estimated costs associated with the nodes of the second intermediate layer, which includes the nodes resulting from expansion of the selected subset of the top intermediate layer nodes. For each available node of the second intermediate layer, the system may determine an estimated cost and determine whether to expand the node based on the estimated cost. This process may be repeated across each intermediate layer until the lowest intermediate layer. The criteria used for selecting nodes for expansion may be the same or different across various intermediate layers. For example, in the top intermediate layer, the system may select a first ratio of the nodes for expansion, while in the second intermediate layer the system may select a second ration of the nodes, where the first ratio may exceed the second ratio.

In some cases, an estimated cost for a node (e.g., an intermediate node) is an estimate of a cost associated with a trajectory passing from a root node of the tree structure to a terminal node (e.g., a leaf node) of the tree structure. The terminal node may be associated with a termination state. The termination state may be associated with a terminating condition. The terminating condition may be determined based on a predefined amount of time (e.g., ten seconds into the future), based on a number of node expansions (e.g., a time period associated with expansion of one thousand nodes), based on a number of layer expansions (e.g., a time period associated with expansion of ten tree structure layers), based on an amount of computational resources used for node expansion (e.g., a time period associated with 10,000 processor-level instructions, and/or the like), and/or the like.

In some cases, the system expands a higher ratio of nodes from a deeper intermediate layer relative to the ratio of nodes expanded from a deeper intermediate layer. For example, given N=3 intermediate layers, the system may expand A percent of the first intermediate layer nodes, B percent of the second intermediate layer nodes, and C percent of the third intermediate layer nodes, where A>B>C. In some cases, this decreasing selection ratio may be based on the understanding that the number of available nodes increases at each deeper layer, and thus a higher degree of selection may be desirable. In some cases, the system allocates a ratio of computing resources to expanding each intermediate layer node that is selected for expansion, where the ratio allocated a higher intermediate layer node may be higher than the ratio allocated to a deeper intermediate layer node. For example, given N=3 intermediate layers, the system may allocate D percent of available computational resources to each node of the first intermediate layer that is selected for expansion, E percent of available computational resources to each node of the second intermediate layer that is selected for expansion, and F percent of available computational resources to each node of the third intermediate layer that is selected for expansion, where D>E>F.

As described above, in some cases, the N hyperparameter defining the number of intermediate layers of the tree structure is determined based on an amount of computational resources available to the planning system. For example, given the available computational resources, the system may determine an optimal value for N based on balancing computational cost and expected gain in planning information. This balancing may be based on the understanding that, given a small value of N, too few nodes may be expanded to find high quality solutions, but given a large value of N, the computational costs grow exponentially and may exceed resource constraints before an optimal solution is found. To balance these tradeoffs, in some cases, the system utilizes cost-benefit analysis to select an optimal value for N. In some cases, the system may estimate the improvement in information gain and/or computational costs for varying values of N, using a pretrained information gain and/or computational cost model. Using these estimations, the system may select the optimal value for N by determining a marginal gain in information gain and a marginal loss in computational cost for each increasing value of N. For example, the system may detect whether a value of N exist after which there will be diminishing returns on information gain given the additional computational resource usage. The optimal value of N may be determined based on this diminishing return cutoff value. In some cases, the value of N is four.

In some cases, an estimated cost for a node (e.g., for an intermediate node in an intermediate layer) is determined using a machine-learned model. In some cases, a machine-learned model for estimating the cost determined by a cost function for a node of a tree structure may include two portions: a set up portion that includes models trained to process static data and a second portion that processes dynamic object data. The respective portions of the model may include various models that determine intermediate outputs that may be projected into a space associated with estimated cost. That estimated cost may identify an estimate of an output of the cost function for paths that are based on the particular node. Example techniques for determining an estimated cost for a node of the tree structure are described in U.S. patent application Ser. No. 18/084,419, entitled “Machine Learned Cost Estimation in Tree Search Trajectory Generation for Vehicle Control,” and filed on Dec. 19, 2022, which is incorporated by reference herein in its entirety and for all purposes.

In some cases, the estimated cost associated with a node is determined based on the distance between a location associated with the node and a target location with respect to which a trajectory is being generated. Nodes estimated to be closer to the target location may be estimated to be associated with deeper costs. In some cases, the estimated cost associated with a node is determined based on one or more paths available for reaching a location associated with the node from the current location of the vehicle. For example, the cost associated with the node may be estimated based on a measure of distance, complexity, safety, and/or policy compliance and/or deviation (e.g., traffic violation intensity) associated with one or more paths from a current location to the node's location. In some cases, nodes along trajectories with tighter turns, narrower lanes, and/or areas known to have higher pedestrian traffic are determined to be associated with higher costs. In some cases, the estimated cost associated with a node is determined based on a traffic condition and/or a historic traffic condition associated with the vehicle's environment. For example, the system may reduce the cost associated with a node if a trajectory associated with reaching the node's location from a current location is determined to be associated with better traffic condition(s) based on current (e.g., real-time) and/or historical traffic data.

In some cases, the techniques described herein enable using a machine-learned estimated cost associated with a node (e.g., an intermediate node) as the measure used for applying “selection heuristic” for selecting which nodes to expand but not as a final measure of cost associated with that node and/or with a trajectory associated with the node. This decoupling of selective node expansion from trajectory cost determination may have many advantages. For example, the decoupling may reduce the effect of imprecisions in the output of the machine-learned model on the overall trajectory evaluation. In some cases, the machine-learned estimated cost may be less reliable when it comes to evaluating trajectories that are infrequently observed in the training data used to train the machine-learned model (e.g., trajectories that are associated with outlier costs, such as unusually high costs or unusually low costs). In some cases, by using the machine-learned estimated cost as a “selection heuristic” measure and not a final measure of trajectory cost, the system may reduce the effect of the machine-learned estimated cost on the overall trajectory selection process.

In some cases, another advantage of decoupling of selective node expansion based on machine-learned estimated cost from trajectory cost determination relates to the ability to make the trajectory cost model more adaptable. In some cases, if the machine-learned estimated cost is used as a final measure of trajectory cost, then incorporating new cost-related factors (e.g., environmental factors, traffic-related factors, and/or the like) into the cost model would require retraining the cost estimation machine-learned model to incorporate the new factors into the input format of the model. In contrast, if the machine-learned estimated cost is not used as a final trajectory cost measure (e.g., if the machine-learned estimated cost is used as one of many inputs to a trajectory cost model), then new cost-related factors may be incorporated into the cost determination model without retraining the machine-learned model.

For example, consider a scenario where a machine-learned model is configured to determine an estimated cost associated with a node N1 based on a set of factors S1 and a trajectory cost determination model is configured to determine a cost for a trajectory T1 that is associated with N1 based on the output of the machine-learned model but without using any trained parameters. In some cases, to incorporate a new cost-related factor (e.g., a new measure of estimated cost) that is not in the set S1 into the trajectory cost determination framework, a developer may change the trajectory cost determination model. This change may cause the logic of the trajectory cost determination model to be changed to incorporate the new cost-related factor without any changes to the machine-learned model used for estimating node costs.

In some cases, the estimated cost associated with an intermediate node is associated with a lower bound determined based on a cost associated with reaching the node from a root node. In some cases, the estimated cost associated with an intermediate node is associated with an upper bound determined based on a deviation between a path from the root node to the particular intermediate node and a maximum-cost path (e.g., a path determined to have the highest cost). In some cases, by bounding the estimated cost between a lower bound based on the cost to reach the node and an upper bound based on the maximum possible cost, the accuracy of the estimated cost may be improved. This in turn can improve the effectiveness of using the estimated cost to guide selective expansion of intermediate nodes in the tree structure.

In some cases, the techniques described herein relate to expanding at least a subset of the subtree depending from a selected node in a bottom-level layer of the tree structure until a terminating condition is reached. A bottom-level layer may be a layer of the tree structure that is at least one layer deeper than the deepest intermediate layer. Accordingly, in some cases, after selective expansion of a set of N intermediate layers, the system may proceed to select a subset of the action nodes associated with the N+1th layer. After selecting a first action node from the N+1th, the system may expand the following until a terminating condition is reached: (i) each action node that has the same action type as the first action node and depends from the first action node, and (ii) each state node that depends from a node expanded in (i). For example, an action node of the N+1th layer may be selected if the action node is determined to be part of a trajectory whose cost up to the N+1th falls below a threshold (e.g., whose cost is among the lowest T of the costs associated with trajectories corresponding to the nodes of the N+1th layer). After selecting the action node, the system may expand each action node that depends from the selected action node and has the same action type until a terminating condition is reached. For example, if the selected action node is a right-turn action, the system may expand all right-action nodes until a terminating condition is reached

For example, in some cases, after expanding the first M layers and selectively expanding the next N layers of a tree structure, the system may determine a set of trajectories based on the expanded layers and a cost associated with those trajectories. Based on these cost determinations, the system may determine a selected subset of the trajectories (e.g., a subset of trajectories associated with the lowest S costs among the set of trajectories, a subset of trajectories whose cost measures fall below a cost threshold, and/or the like). The system may then determine which nodes of the M+N+1th layer correspond to the selected subset and expand at least a portion of the subtrees corresponding to those selected nodes until a terminating condition is reached.

As another example, in some cases, after expanding the first M layers and selectively expanding the next N layers of a tree structure, the system may determine an estimated cost for each node of the M+N+1th layer. The estimated cost may be determined, for example, using the same techniques used for determining estimated costs for the intermediate layer nodes. After determining the estimated cost for the nodes of the M+N+1th layer, the system may determine a selected subset of the nodes from the M+N+1th layer (e.g., a subset of nodes with lowest Q costs among the set of nodes of the M+N+1th layer, a set of nodes whose cost measures fall below a cost threshold, and/or the like). The system may then fully expand downstream actions nodes depending from and having the same action type as one of the action nodes in the selected subset until a terminating condition is reached.

In some cases, the system may expand a node that depends from a node of a layer that is deeper than the deepest intermediate layer (e.g., the M+N+1th layer, where M is the number of top-level layers and N is the number of intermediate layers) until a terminating condition is reached. For example, the system may: (i) identify a layer of the tree structure that is deeper than the deepest intermediate layer, (ii) select a node from the identified layer, and (iii) expand each node that depends from and has the same type as the selected node until a terminating condition is reached. In some cases, a ratio of the nodes of the layer deeper than deepest intermediate layer may be selected, where this selection ratio may in some cases be determined based on an amount of available computational resources. For example, the system may select fifty percent of the nodes from the bottom-most layer.

The terminating condition may be determined based on a predefined amount of time (e.g., ten seconds into the future), based on a number of node expansions (e.g., a time period associated with expansion of one thousand nodes), based on a number of layer expansions (e.g., a time period associated with expansion of ten tree structure layers), based on an amount of computational resources used for node expansion (e.g., a time period associated with 10,000 processor-level instructions, and/or the like), and/or the like. In some cases, the terminating condition is determined based on a receding planning horizon. In some cases, the terminating condition is determined based on a time window that represents a receding window.

For example, in some cases, the terminating condition may be satisfied when a predefined maximum depth of the tree is reached (e.g. twenty layers deep). As another example, in some cases, the terminating condition may be satisfied when a target number of total nodes in the tree have been expanded (e.g., 100,000 nodes). As another example, in some cases, the terminating condition may be satisfied when expanding additional nodes only adds a minimal amount of new information and/or diversity to the tree (e.g. less than a five percent increase in unique node types by expanding further). As another example, in some cases, the terminating condition may be satisfied when a model monitoring the tree expansion determines that the likelihood of a tree expansion with significant information gain falls below a threshold. As another example, in some cases, the terminating condition may be satisfied when the amount of computational resources (e.g., processing resources, memory resources, and/or the like) allocated to the tree expansion is fully utilized.

In some cases, an example system may determine whether a termination state is reached for one or more of the set of nodes that are deeper than the intermediate node(s). The termination state may indicate whether a given node reaches the end of the receding time horizon. Nodes that do not reach the termination state prior to completion of the tree search may be pruned from the tree structure. This may ensure that that only nodes reaching the full time horizon are considered when determining the optimal trajectory. By limiting trajectory selection to fully expanded nodes at the termination state, the system reduces the effect of potential errors in the learned cost model for nodes that did not fully expand. Similarly, all nodes that do reach a termination state may be further associated with a termination cost which may be an estimate of the total cost to traverse from the termination state to a final, desired, destination (which, in some cases, may be further in time or space from the termination state).

In some cases, the techniques described herein relate to determining a cost for a trajectory based on an expanded tree structure. In some cases, the system determines a cost associated with one or more trajectories by utilizing the expanded nodes of the tree structure. For example, an initial tree structure representing trajectories for a vehicle may be expanded out to a predefined depth. Various node expansions may represent additional permutations of trajectories along different possible paths. Once the tree is expanded, costs may be calculated for trajectories based on the node types traversed.

In some cases, the cost associated with a trajectory may be determined based on: (i) a measure determined based on estimated costs associated with one or more nodes associated with a trajectory (e.g., as determined using a machine-learned model), and (ii) one or more other measures (e.g., environmental cost measures, traffic-related cost measures, cost measures associated with deviations from one or more driving policies, cost measures associated with deviations from one or more reference trajectories, and/or the like). In some cases, the cost measure associated with a trajectory may be determined by processing one or more cost measures associated with the trajectory using a cost determination model. The cost determination model may, for example, be a weighted combination model, a regression model (e.g., a linear regression model, and/or the like), and/or the like. As described above, in some cases, using a cost determination model to evaluate a trajectory may decouple selective node expansion using a machine-learned model from trajectory cost determination, which may reduce the need for retraining the machine-learned model and/or reduce the effects of biases associated with the machine-learned model on trajectory evaluation.

In some cases, the techniques discussed herein can be implemented to facilitate and/or enhance safety of automated navigation features in vehicles, such as in automated vehicles or semi-automated vehicles. For example, the techniques can be used to determine a trajectory for an autonomous vehicle and control the autonomous vehicle based on the trajectory. As another example, the techniques can be used to determine that a current trajectory of a vehicle is likely to collide with an object that is within the environment of the vehicle. Upon determining that the current trajectory is likely to collide with an object, the driver of the vehicle may be stopped from following the current trajectory and/or the driver of the vehicle may be alerted about the likelihood of collision. In some cases, upon determining that the current trajectory of an autonomous vehicle is likely to collide with an object in the autonomous vehicle environment, the driver of the autonomous vehicle may be alerted to exercise manual control of the autonomous vehicle.

In some cases, the techniques described herein reduce computational costs and memory usage associated with decision tree expansion. In some cases, the techniques described herein enable selective expansion of a tree structure used for trajectory planning and vehicle control. By selectively expanding the tree via focusing on higher quality branches, the system can reduce computational costs and memory usage compared to exhaustively expanding the full tree. This also enables the tree search method to scale more efficiently and/or with lower latency. In some cases, comparing the properties of different sibling sets that result from actions in a parent state, redundant expansions can be avoided. In some cases, coly sibling sets that are sufficiently distinct are expanded. This may prevent expanding redundant states that would not provide significant new information. Additionally or alternatively, the preserved computational resources may be reallocated to further improve the search over remaining nodes (e.g., longer time horizons over the tree search, exploring additional actions, or the like).

The methods, apparatuses, and systems described herein can be implemented in a number of ways. Example implementations are provided below with reference to the following figures. Although discussed in the context of a vehicle, the methods, apparatuses, and systems described herein can be applied to a variety of systems using trajectory planning techniques and are not limited to vehicles. Moreover, although various trajectory planning operations are described as being performed by a planning component of a vehicle computing device, a person of ordinary skill in the relevant technology will recognize that the planning component may be deployed on other computing devices, such as on a remote computing device that communicates with a vehicle computing device using a networked connection.

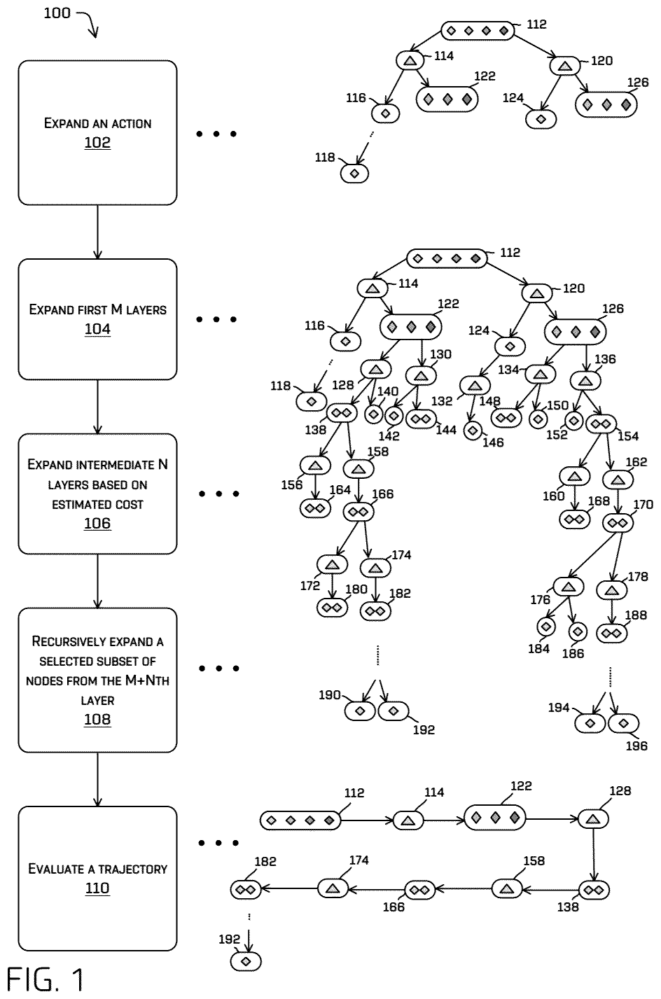

FIG. 1 is a flowchart diagram of an example process 100 for evaluating a candidate trajectory by selectively expanding a tree structure (e.g., a decision tree). As depicted in FIG. 1, at operation 102, an example system expands one or more nodes of the tree structure that correspond to a predefined action. The predefined action may include at least one of stopping the vehicle, turning the vehicle to the right, turning the vehicle to the left, or stopping the action. In some cases, expanding nodes associated with predefined actions enables evaluating trajectories that include those predefined actions, which in turn provides backup trajectories for the vehicle to use if a more optimal trajectory is not determined during the tree search.

As depicted in FIG. 1, expanding an example tree structure based on a predefined action includes expanding state node 112, state node 116, and any other state node that is a direct or indirect parent of state node 118. Expansion of state node 112 includes expansion of each action node that depends directly from that node, which means expansion of action node 114 and expansion of action node 120. An action node may depend from a state node and represent an action that is available and/or predicted to be available at a state associated with the state node. Accordingly, expansion of the example tree structure depicted in FIG. 1 results in a tree structure that includes the node 112, node 114, node 116, node 118, node 120, node 122, node 124, and node 126. While the example expansion depicted in FIG. 1 includes expanding the tree structure based on a single predefined action, a person of ordinary skill in the relevant technology will recognize that the tree structure may be expanded based on more than predefined action. The set of predefined action(s) may enable determining an upper-bound for the cost associated with the selected trajectory.

At operation 104, the system expands the first M layers of the tree structure. In some cases, the system expands each node of the tree structure that is associated with one of the M top layers of the tree structure. In relation to the example tree depicted in FIG. 1, performing the operation 102 includes expanding state node 112 to via action node 114 and action node 116 to determine state node 116, state node 122, state node 124, and state node 126; expanding state node 116; expanding state node 122 via action node 128 and action node 130 to determine state node 138, state node 140, state node 142, and state node 144; expanding state node 124 via action node 132 to determine state node 146; and expanding state node 126 via action node 134 and action node 136 to determine state node 148, state node 150, state node 152, and state node 154. Accordingly, in relation to the example tree depicted in FIG. 1, M=2 top layers of the tree structure are fully expanded.

At operation 106, the system selectively expands the intermediate N layers of the tree structure. In some cases, selective expansion of the N intermediate layers includes, for each of the N intermediate layers starting from the highest intermediate layer: (i) identify the already-determined nodes associated with that layer, (ii) for an identified node, determine whether an estimated cost should be determined using a machine-learned model and/or determine an estimated cost using a machine-learned model, and (iii) determine a subset of the identified nodes to expand based on the determined estimated costs.

For example, in some cases, the system may first identify the nodes of the M+7th layer resulting from expansion of the nodes of the Mth layer. The system may determine, for each node of the M+1th layer, an estimated cost. The system may determine whether to expand a node of the M+1th layer based on the estimated costs associated with that node. For example, the system may determine to expand the node if the estimated cost associated with the node falls below a threshold, if the estimated cost associated with the node is among the lowest G costs associated with the nodes of the M+1th layer, if the estimated cost associated with the node is among the lowest H percentage of the costs associated with the nodes of the M+1th layer, and/or the like.

As another example, in some cases, after selectively expanding the nodes of the M+1th layer, the system may obtain a resulting set of nodes associated with the M+2th layer. Afterwards, the system may determine, for each node of the M+2th layer, an estimated cost. The system may determine whether to expand a node of the M+2th layer based on the estimated costs associated with that node. For example, the system may determine to expand the node if the estimated cost associated with the node falls below a threshold, if the estimated cost associated with the node is among the lowest I costs associated with the nodes of the M+2th layer, if the estimated cost associated with the node is among the lowest J percentage of the costs associated with the nodes of the M+2th layer, and/or the like.

As another example, in some cases, after selectively expanding the nodes of the M+2th layer, the system may obtain a resulting set of nodes associated with the M+3th layer. Afterwards, the system may determine, for each node of the M+3th layer, an estimated cost. The system may determine whether to expand a node of the M+3th layer based on the estimated costs associated with that node. For example, the system may determine to expand the node if the estimated cost associated with the node falls below a threshold, if the estimated cost associated with the node is among the lowest K costs associated with the nodes of the M+3th layer, if the estimated cost associated with the node is among the lowest L percentage of the costs associated with the nodes of the M+3th layer, and/or the like. This process may continue until all of the N intermediate layers are selectively expanded.

In relation to the example tree structure depicted in FIG. 1, selective expansion of the tree structure includes selective expansion of the third and fourth layer. In the third layer, the system expands state node 138 and state node 154, while refraining from expansion of state node 140, state node 142, state node 144, state node 146, state node 148, state node 150, and state node 154. Expansion of state node 138 via action node 156 and action node 158 causes creating state node 164 and state node 166. Expansion of state node 154 via action node 160 and action node 162 causes generation of state node 178 and state node 170. Accordingly, the fourth layer of the tree structure is associated with the state node 164, the state node 166, state node 168, and state node 170.

In the fourth layer of the example tree structure depicted in FIG. 1, the system expands state node 166 and state node 170, while refraining from expanding state node 164 and state node 168. Expansion of state node 166 via action node 172 and action node 174 causes creation of state node 180 and state node 182. Expansion of state node 170 via action node 176 and action node 178 causes creation of state node 184, state node 186, and state node 188. Accordingly, the fifth layer of the tree structure is associated with the state node 180, state node 182, state node 184, state node 186, and state node 188.

At operation 108, the system fully expands a selected subset of the nodes from M+Nth layer. For example, the system may determine a set of more promising trajectories based on the data associated with the top M+N layers. The system may then expand each node of the M+Nth layer that is associated with a promising trajectory and each node that depends from and/or has the same type (e.g., the same action node) as an expanded M+Nth layer node until a terminating condition is reached. The terminating condition may be determined based on a predefined amount of time (e.g., ten seconds into the future), based on a number of node expansions (e.g., a time period associated with expansion of one thousand nodes), based on a number of layer expansions (e.g., a time period associated with expansion of ten tree structure layers), based on an amount of computational resources used for node expansion (e.g., a time period associated with 10,000 processor-level instructions, and/or the like), and/or the like. In some cases, the terminating condition is determined based on a receding planning horizon. In some cases, the terminating condition is determined based on a time window that represents a receding window.

As depicted in FIG. 1, expanding the example tree structure depicted in that figure includes, at operation 108, expanding state node 182 and state node 188 associated with the fifth layer until a terminating condition is reached (e.g., until the end of a receding planning horizon), while state nodes 180, 184, and 186, which are also associated with the fifth layer, are not expanded. As further depicted in FIG. 1, expansion of at least a portion of the subtree depending from node 182 results in a set of nodes including state node 190 and node 192, while expansion of at least a portion of the subtree depending from node 188 results in a set of nodes including state node 194 and state node 196.

At operation 110, the system evaluates a trajectory. The system may evaluate the trajectory based on the tree structure resulting from expansion operations performed in the preceding operations. For example, the system may determine a cost for a trajectory that is associated with the state node 112, action node 114, state node 122, action node 128, state node 138, action node 158, state node 166, action node 174, state node 182, and state node 192. The cost for this trajectory may be determined based at least in part on estimated costs associated with at least some of the tree structure nodes that are associated with that trajectory. Such a lowest cost trace trajectory through the tree structure may then be used for subsequent control of the vehicle.

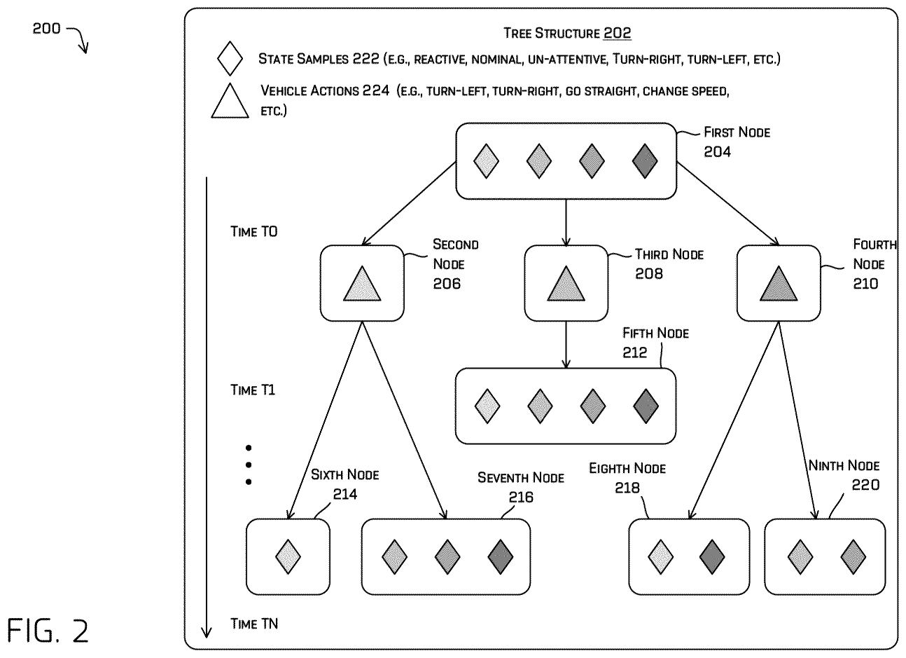

FIG. 2 provides an operational example 200 of a tree structure 202 that may be used to perform trajectory planning for a vehicle. The tree structure 202 includes one or more state nodes and one or more action nodes. A state node may be a collection of one or more state samples 222. A state sample may represent data about an object in the vehicle environment, such as a predicted object intent. Object intents can represent a level of attentiveness of the object, such as whether the object will react to the vehicle with a first level of reactiveness or a second level of reactiveness, or in some cases, not react to the vehicle during a sample. In various examples, different levels of reactiveness can be associated with different maximum thresholds for the object to accelerate, brake, or steer. The object intent can include, for example, one or more of: a) a reactive intent in which an object changes lanes, brakes, accelerates, decelerates, etc. relative to the vehicle, b) a nominal intent in which the object changes lanes, brakes, accelerates, decelerates, etc. less aggressively than the reactive intent such as decelerate to allow the vehicle to lane change, c) an un-attentive intent in which the object refrains from reacting to the vehicle, d) a right turn intent, e) a left turn intent, f) a straight intent, g) an accelerating intent, h) a decelerating intent, i) a parking intent, j) a remain in place intent, etc.). The action nodes may correspond to a set of actions 224 (e.g., a turning action, braking action, acceleration action such as yielding to or slowing for an object to safely enter in front of the vehicle). In at least some examples, such actions may comprise alternative trajectories and the nodes may specify which of the action trajectories should be tracked (used as a reference for motion) at a given point in time associated with the node.

In some examples, the object intents corresponding to the state samples of the tree structure 202 can be associated with a most relevant object(s) to the vehicle. For example, the system may receive one or more objects determined to be relevant to the vehicle by another machine learned model configured to identify a relevant object from among a set of objects in an environment of the vehicle. The machine learned model can determine the relevant object based at least in part on a relevancy score associated with each object in the set of objects and/or object(s) within a threshold distance from the vehicle. Additional examples of determining relevance of an object are described in U.S. patent application Ser. No. 16/530,515, filed on Aug. 2, 2019, entitled “Relevant Object Detection,” Ser. No. 16/417,260, filed on May 30, 2019, entitled “Object Relevance Determination,” and Ser. No. 16/389,720, filed on May 6, 2019, entitled “Dynamic Object Relevance Determination,” all of which are incorporated herein by reference in their entirety and for all purposes.

In some examples, a state node(s) of the tree structure 202 can be associated with one or more regions surrounding the vehicle (e.g., a region most likely to include a potential intersection point with an object). For example, the system can receive one or more regions determined by a model configured to identify a relevant region from among a set of regions in the environment of the vehicle. For instance, the tree structure can include node(s) to represent an occluded region, a region in front of the vehicle, or other area within a predetermined distance of the vehicle. In some examples, the vehicle is a bi-directional vehicle, and as such, the model can define, identify, or otherwise determine the rear region relative to a direction of travel as the vehicle navigates in the environment. For instance, the rear region of the vehicle can change depending upon the direction of travel. In at least some examples, the environment may be encoded as a vector representation and output from a machine learned model as an embedding. Such an embedding may be used in predicting the future state(s) or intent(s) of the object. As such, the state samples 22 may represent a state of the vehicle, one or more objects proximate the vehicle, the environment through which the vehicle is traversing, or any other representation of how the environment evolves given the action of the immediately preceding node. As shown, for example in a fifth node 212, such an action may result in a variety of states of beliefs and the distribution of beliefs may be recorded and stored in the tree structure.

The tree structure 202 includes a first node 204, a second node 206, a third node 208, a fourth node 210, a fifth node 212, a sixth node 214, a seventh node 216, an eighth node 218, and a ninth node 220, though other number of nodes are possible. For instance, the first node 204 can include four different object intents as depicted by different shading. The second node 206, the third node 208, and the fourth node 210 can be associated with corresponding vehicle actions (e.g., a proposed action or action for the vehicle to take in the future). In various examples, the second node 206, the third node 208, and/or the fourth node 210 can represent actions for applying to the vehicle over a period of time.

In the example illustrated, intents grouped together may either elicit a similar or same response from the vehicle and/or have substantially similar probabilities/confidences/likelihoods of occurrence. As illustrated, taking certain actions by the vehicle may aid in differentiating a response of the object as illustrated by varying groupings of object intents in response to vehicle actions. Further differentiation of the object intents may, in some instances, yield better responses by the vehicle to the environment (e.g., safer, more efficient, more comfortable, etc.).

The tree structure 202 is associated with a period of time as shown in FIG. 2. For example, time TO represents a first time of the tree structure 202 and is generally associated with the first node 204 and the second node 206. Each progression of the tree structure 202 to a new node does not necessarily imply a new time (e.g., TO, T1, etc. is not scaled to the nodes in FIG. 2 but used to show a progression of time generally). In some examples, each layer of the tree structure can be associated with a particular time (e.g., the first node 204, the second node 206, the third node 208, and the fourth node 210 are associated with time T0, the fifth node 212, the sixth node 214, the seventh node 216, the eighth node 218, and the ninth node 220 are associated with time T1, and so on for additional branches or nodes (not shown) up to time TN, where N is an integer. In various examples, different layers, branches, or nodes can be associated with different times in the future. In various examples, scenarios associated with one or more of the nodes of the tree structure 202 can run in parallel on one or more processors (e.g., Graphics Processing Unit (GPU) and/or Tensor Processing Unit (TPU), etc.).

In some examples, at time T1 the vehicle takes an action associated with the third node 208 at the fifth node 212, followed by additional scenarios to test how the vehicle responds to the four object intents of the fifth node 212. Further, the tree structure 202 can represent a vehicle action associated with the second node 206, and perform additional tests at time T1 to determine how the vehicle responds to the object intent of the sixth node 214 (e.g., turn left intent) and the three object intents of the seventh node 216. In some examples, the three object intents of the seventh node 216 can include a same outcome, such as the object having a straight intent but each straight intent may be associated with different levels of response to the vehicle (e.g., different velocities, accelerations, and/or braking capabilities). In various examples, the sixth node 214 (or another node having a single object intent) enables evaluation of a specific object intent (e.g., a left turn that is less likely to occur that, for example, the object continuing straight and not turning left) on the vehicle trajectory determination.

In various examples, a different vehicle action at the fourth node 210 can cause additional tests (scenarios) to be performed to determine how the vehicle responds to the two object intents of the eighth node 218 and the two object intents of the ninth node 220.

Note that in the depicted example in FIG. 2, the nodes after the vehicle actions in time (e.g., second node 206, third node 208, and fourth node 210) can be considered sub-nodes, or child nodes, and the total number of object intents between sub-nodes equals an amount of object intents in the first node 204. For example, the sixth node 214 and the seventh node 216 have four object intents combined, which is equal to the four object intents of the first node 204. In other examples, however, the object intents can change between nodes and the number of object intents can also vary by node (e.g., may be more or less than the number of object intents in the first node of the tree structure).

In some examples, additional nodes (not shown) can be searched in the tree structure 202 to test another object intent or group of object intents. For example, at time T2, a new set of samples and/or a new set of object intents can be associated with a node of the tree structure 202 based at least in part on an output of a previous node. In some examples, a new combination of object intents can be assigned to a node by a model to further consider different object actions when determining a vehicle trajectory. By receiving a new set of samples different from the set of samples used in previous nodes, nodes of the tree structure 202 can be “re-sampled” dynamically during a tree search, for example.

In various examples, the system can generate the tree structure 202 based at least in part on one or more of: an attribute (e.g., position, velocity, acceleration, yaw, etc.) of the objects, history of the objects (e.g., location history, velocity history, etc.), an attribute of the vehicle (e.g., velocity, position, etc.), and/or features of the environment (e.g., roadway boundary, roadway centerline, crosswalk permission, traffic light permission, and the like). In some examples, a node of the tree structure 202 can be associated with various costs (e.g., comfort cost, safety cost, distance cost, brake cost, obstacle cost, etc.) usable for determining a potential intersection point between the vehicle and the object in the future. A comfort cost may be a measure of passenger comfort while continuing a trajectory. For example, a trajectory with high levels of traffic may have a higher comfort cost relative to a trajectory with a lower comfort cost.

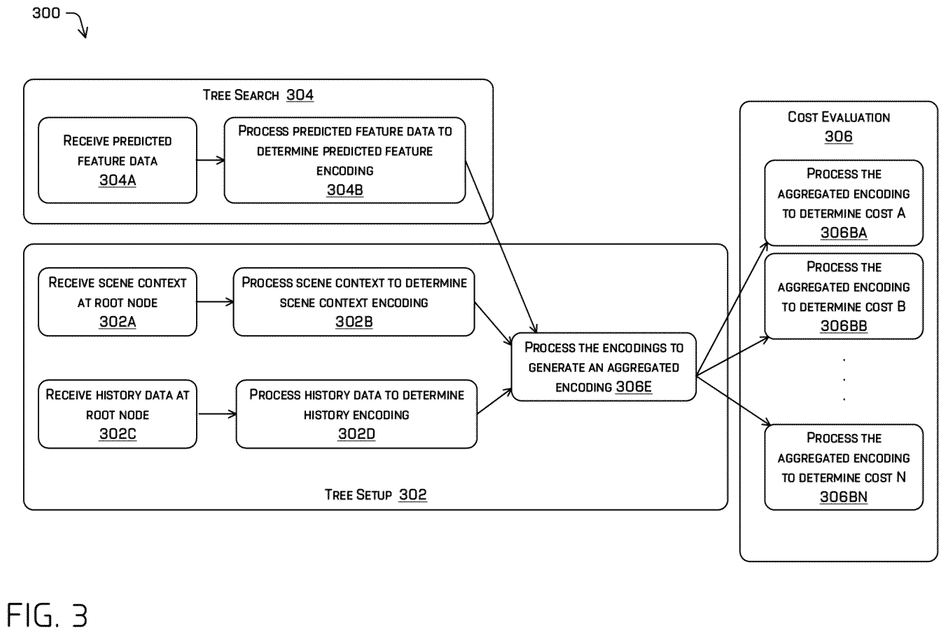

FIG. 3 is a flowchart diagram of an example process 300 for determining one or more cost measures for a trajectory using a tree structure. As depicted in FIG. 3, the process 300 includes three phases: tree setup phase 302, tree search phase 304, and cost evaluation phase 306. The tree setup phase 302 may include determining current state data associated with a current state represented by the root node of the tree structure. The tree search phase 304 may include determining predicted state data associated with a future predicted state represented by a downstream node of the tree structure and/or a state sample of a downstream node of the tree structure. The cost evaluation phase 306 phase may include determining N cost measures for a trajectory associated with a downstream node of the tree structure based on the current state data generated by the tree setup phase 302 and predicted state data generated by the tree search phase 304.

As depicted in FIG. 3, at operation 302A, the tree setup phase 302 includes receiving current scene context data associated with the root node of a tree structure. The current scene context data may represent a state (e.g., at least one of a position, an orientation, a velocity, and/or the like) of an object (e.g., a static object such as a roadway feature, a dynamic object such as a pedestrian and/or a vehicle, and/or the like) at a current time. The current time may be the latest time for which sensor data and/or perception data is available. In some cases, the current scene context data includes a top-down representation of an environment of a vehicle at a current time.

At operation 302B, the tree setup phase 302 includes processing the current scene context data to determine a current scene context encoding. For example, the system may process the current scene context data (e.g., a top-down representation of the vehicle environment) using a trained machine-learned model (e.g., a trained machine-learned model with one or more convolutional neural network layers) to determine the current scene context encoding. In some cases, the current scene context encoding includes a defined number of encoding channels, where the number of encoding channels may be defined by a hyper-parameter of the model used to determine the current scene context encoding. In some cases, a channel of the current scene context encoding is a two-dimensional matrix with a defined height and width value, for example a defined height and width value determined based on dimensions of a top-down representation of the vehicle's environment.

At operation 302C, the tree setup phase 302 includes receiving history data associated with one or more objects in the vehicle environment. The history data may represent one or more previous actions and/or previous states associated with one or more objects (e.g., one or more vehicles including the ego vehicle for which a trajectory is being generated, one or more pedestrians, and/or the like) in the vehicle environment. In some cases, the history data may represent one or more previous actions and/or previous states associated with one or more objects over a period of time, such as a statically or dynamically defined time period. In some cases, the history data is a three-dimensional data structure, where a first dimension may be associated with the number of objects associated with the history data, a second dimension may be associated with a number of timesteps captured by the history data, and a third dimension history may be associated with the number of engineered features represented by the history data.

At operation 302D, the tree setup phase 302 includes determining a history encoding based on the received history data. The history encoding may be determined by processing the received history data using a trained machine-learned model (e.g., a trained machine-learned model with one or more recurrent neural network layers, such as one or more graph-based recurrent neural network layers). The history encoding may include a defined number of encoding channels, where the number of encoding channels may be defined by a hyper-parameter of the model used to determine the history encoding. In some cases, a channel of the history encoding may be a two-dimensional structure with a first dimension associated with the number of monitored objects in the environment and/or a second dimension associated with a number of engineered features for each object.

As further depicted in FIG. 3, at operation 304A, the tree search phase 304 includes receiving predicted feature data associated with one or more objects in the environment at a future time associated with a target state node and/or a target state sample. The predicted feature data may include a state (e.g., at least one of a position, an orientation, a velocity, and/or the like) of one or more objects. The predicted feature data may be a three-dimensional structure, where a first dimension of the three-dimensional structure may be associated with a number of future timesteps captured by the predicted feature data (e.g., as determined based on a depth level of the target state node and/or the target state sample), a second dimension may be associated with a number of monitored objects in the environment, and/or a third dimension may be associated with a number of engineered features captured by the predicted feature data.

At operation 304B, the tree search phase 304 includes determining a predicted feature encoding for the target state node and/or the target state sample based on the received predicted feature data. Determining the predicted feature encoding may include processing the received predicted feature data using a trained machine-learned model (e.g., a trained machine-learned model including one or more graph neural network layers). In some cases, the predicted feature encoding may include a defined number of encoding channels, where the number of encoding channels may be defined by a hyper-parameter of the model used to determine the predicted feature encoding. A channel of the predicted feature encoding may have a dimension corresponding to the number of monitored objects in the environment.

As further depicted in FIG. 3, at operation 306E, the tree setup phase 302 includes processing at least two of the scene context encoding, the history encoding, and the predicted feature encoding to determine an aggregated encoding. Processing the encodings may include at least one of concatenating, averaging, summing, and/or the like. In some cases, the encodings may include processing the encodings using a trained aggregation model.

At operations 306A-306N, the cost evaluation phase 306 includes processing the aggregated encoding using N cost models to determine N cost measures. Each cost measure may represent a measure of cost associated with a trajectory that is associated with the target state node and/or the target state sample. Examples of such costs include progression cost, policy adherence cost, safety cost, and/or the like. Accordingly, at operation 306A, the cost evaluation phase 306 includes processing the aggregated encoding using N cost models to determine a first cost measure; at operation 306B, the cost evaluation phase 306 includes processing the aggregated encoding using N cost models to determine a second cost measure; at operation 306N, the cost evaluation phase 306 includes processing the aggregated encoding using N cost models to determine an Nth cost measure; and so on. The N cost measures may, in some cases, be combined to determine a final cost measure that may be used for trajectory evaluation and/or selection.

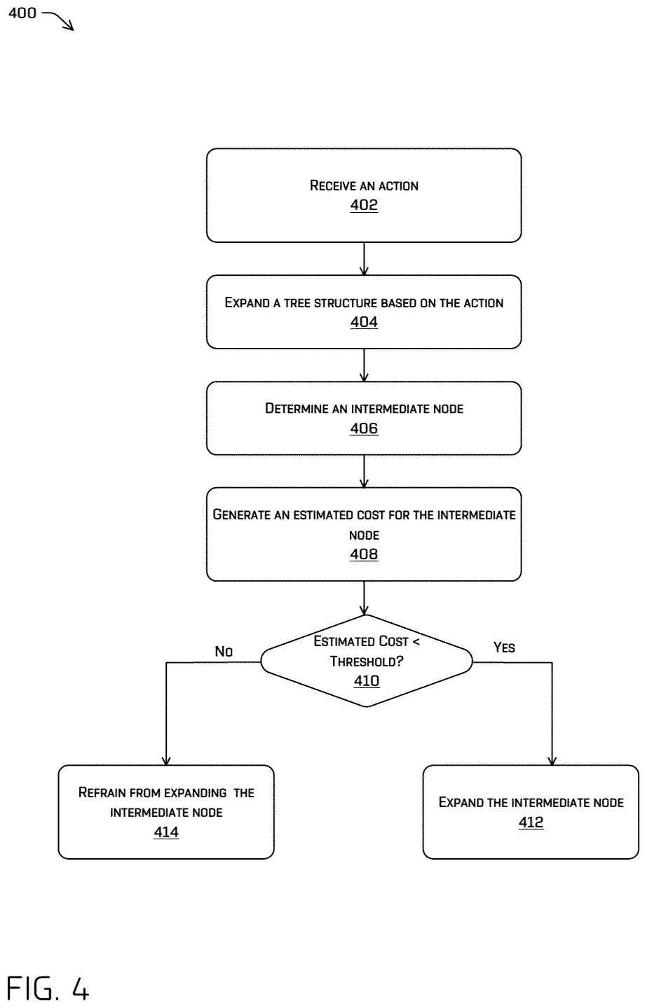

FIG. 4 is a flowchart diagram of an example process 400 for selective expansion of a tree structure up to an intermediate layer. At operation 402, an example system receives a predefined action. The predefined action may include at least one of stopping the vehicle, turning the vehicle to the right, turning the vehicle to the left, or stopping the action. The predefined action may be one of a predefined set of actions associated with a planning iteration (e.g., with a current time).

At operation 404, the system expands a tree structure based on the predefined action. In some cases, expanding a tree structure based on a predefined action may include expanding each node of the tree structure that corresponds to the action. The expansion of action-related nodes may be performed until a terminating condition is reached. The terminating condition may be determined based on a predefined amount of time (e.g., ten seconds into the future), based on a number of node expansions (e.g., a time period associated with expansion of one thousand nodes), based on a number of layer expansions (e.g., a time period associated with expansion of ten tree structure layers), based on an amount of computational resources used for node expansion (e.g., a time period associated with 10,000 processor-level instructions, and/or the like), and/or the like.

At operation 406, the system determines an intermediate node of the tree structure. The intermediate node may be a node that is associated with an intermediate layer of the tree structure. The intermediate layers may include layers M+1 to M+N. In some cases, M is a predefined value, such as one or two. In some cases, N is determined based on a predefined value (e.g., a predefined value of four) or a value determined based on a prediction about available computational resources of the system at a time in which intermediate layers are designated as such.

At operation 408, the system generates an estimated cost for the intermediate node. The system may process one or more features associated with the intermediate node using a machine-learned model to determine an estimated cost. Example techniques for determining an estimated cost for a node of the tree structure are described in U.S. patent application Ser. No. 18/084,419, entitled “Machine Learned Cost Estimation in Tree Search Trajectory Generation for Vehicle Control,” and filed on Dec. 19, 2022, which is incorporated by reference herein in its entirety and for all purposes.

At operation 410, the system determines whether the estimated cost associated with the intermediate node falls below a cost threshold. The threshold may be determined based on a predefined value and/or a dynamically-determined value (e.g., a value configured to cause a required ratio of the intermediate nodes in the same intermediate layer that have the lowest estimated costs to be selected). If the system determines that the estimated cost falls below the threshold (operation 410-Yes), the system proceeds to operation 412 to expand the intermediate node. If the system determines that the estimated cost does not fall below (e.g., exceeds or equals) the threshold (operation 410-Yes), the system proceeds to operation 414 to refrain from expanding the intermediate node.

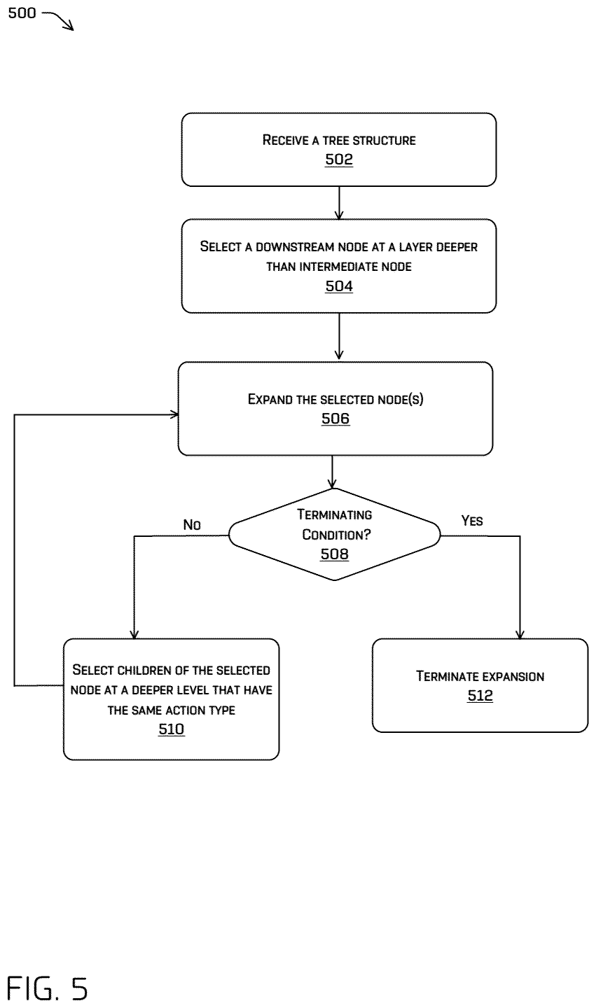

FIG. 5 is a flowchart diagram of an example process 500 for expanding a tree structure at a layer deeper than an intermediate layer (e.g., at a layer deeper than the deepest intermediate layer). As depicted in FIG. 5, at operation 502, an example system receives a tree structure. The tree structure may result from at least one of: (i) generating a root node of the tree structure based on a current and/or latest state of an environment of a vehicle, (ii) expanding each node of the tree structure that is associated with a predefined set of actions until a terminating condition is reached and/or for a period of time, or (iii) expanding each node of the tree structure that is associated with the first M layers.

At operation 504, the system selects a downstream node that is at a layer deeper than an intermediate node (e.g., at a layer deeper than all intermediate node). In some cases, the system determines, as a selected downstream node, a node of the layer that is immediately deeper than the deepest intermediate layer, if the node is associated with an estimated cost that falls below a threshold and/or if the node is associated with a trajectory whose cost falls below a threshold.

At operation 506, the system expands the selected downstream node. In some cases, if operation 506 is performed after operation 504, the selected downstream node is a node of the layer that is immediately deeper than the deepest intermediate layer. In some cases, if operation 506 is performed after operation 510, the selected downstream node(s) include a set of Lth level children of the node of the layer that is immediately deeper than the deepest intermediate layer, where the value of Z may increase during each iteration.

At operation 508, the system determines whether a terminating condition is reached. The terminating condition may be determined based on a predefined amount of time (e.g., ten seconds into the future), based on a number of node expansions (e.g., a time period associated with expansion of one thousand nodes), based on a number of layer expansions (e.g., a time period associated with expansion of ten tree structure layers), based on an amount of computational resources used for node expansion (e.g., a time period associated with 10,000 processor-level instructions, and/or the like), and/or the like.

If the system determines that the terminating condition is not reached (operation 508-No), the system proceeds to operation 510 to select children of the selected node at a deeper level and have the same action type as the downstream node and then expands those selected children at operation 506. If the system determines that the terminating condition is reached (operation 508-Yes), the system proceeds to operation 512 to terminate expansion and/or designate the last added node as the final node of the tree structure. In some cases, a final node is added to the tree structure based on whether a trace that includes that node reaches a termination state. A final node may be a node associated with a final layer (e.g., a leaf layer) of the tree structure.

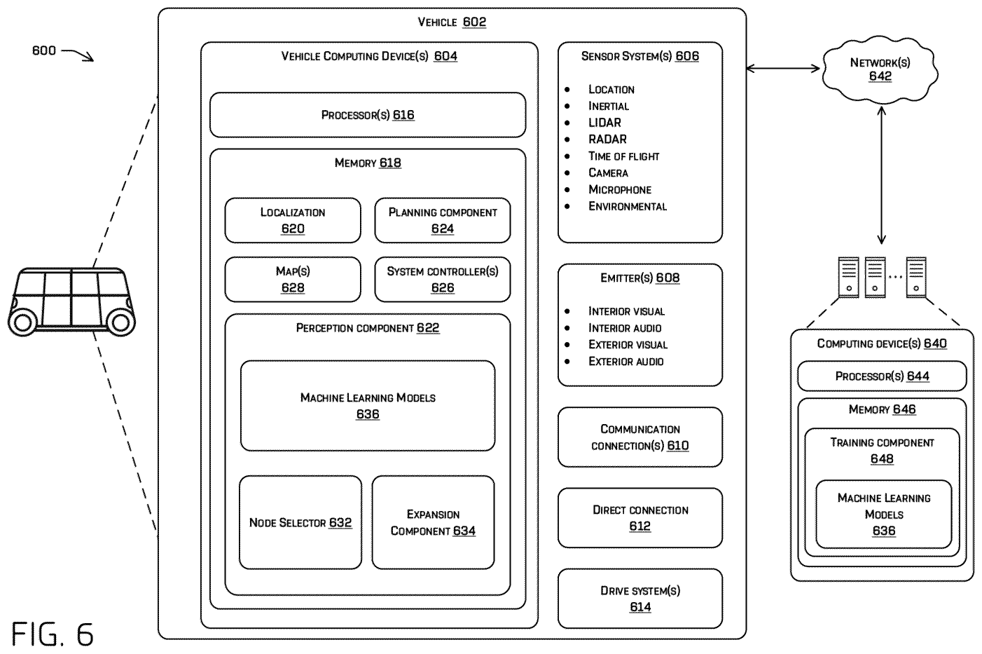

FIG. 6 depicts a block diagram of an example system 600 for implementing the techniques described herein. In at least one example, the system 600 may include a vehicle 602.

The vehicle 602 may include a vehicle computing device 604, one or more sensor systems 606, one or more emitters 608, one or more communication connections 610, at least one direct connection 612, and one or more drive systems 614.

The vehicle computing device 604 may include one or more processors 616 and memory 618 communicatively coupled with the one or more processors 616. In the illustrated example, the vehicle 602 is an autonomous vehicle; however, the vehicle 602 could be any other type of vehicle. In the illustrated example, the memory 618 of the vehicle computing device 604 stores a localization component 620, a perception component 622, a planning component 624, one or more system controllers 626, and one or more maps 628. Though depicted in FIG. 6 as residing in memory 618 for illustrative purposes, it is contemplated that the localization component 620, the perception component 622, the planning component 624, the one or more system controllers 626, and the one or more maps 628 may additionally, or alternatively, be accessible to the vehicle 602 (e.g., stored remotely).

In at least one example, the localization component 620 may include functionality to receive data from the sensor system(s) 606 to determine a position of the vehicle 602. For example, the localization component 620 may include and/or request/receive a three-dimensional map of an environment and may continuously determine a location of the autonomous vehicle within the map. In some instances, the localization component 620 may utilize SLAM (simultaneous localization and mapping) or CLAMS (calibration, localization and mapping, simultaneously) to receive image data, lidar data, radar data, IMU data, GPS data, wheel encoder data, and the like to accurately determine a location of the autonomous vehicle. In some instances, the localization component 620 may provide data to various components of the vehicle 602 to determine an initial position of an autonomous vehicle for generating a candidate trajectory.

In some instances, the perception component 622 may include functionality to perform object detection, segmentation, and/or classification. In some examples, the perception component 622 may provide processed sensor data that indicates a presence of an entity that is proximate to the vehicle 602 and/or a classification of the entity as an entity type (e.g., car, pedestrian, cyclist, building, tree, road surface, curb, sidewalk, unknown, road feature, etc.). In examples, the perception component 622 may process sensor data to identify a road feature (e.g., an intersection, parking lane, signal light, stop sign, etc.), determine a proximity of the road feature to the vehicle 602, and/or provide data regarding the road feature (e.g., proximity, etc.) as processed sensor data. In additional and/or alternative examples, the perception component 622 may provide processed sensor data that indicates one or more characteristics associated with a detected entity and/or the environment in which the entity is positioned. In some examples, characteristics associated with an entity may include, but are not limited to, an x-position, a y-position, a z-position, an orientation, an entity type (e.g., a classification), a velocity of the entity, an extent of the entity (size), etc. Characteristics associated with the environment may include, but are not limited to, a presence of another entity in the environment, a state of another entity in the environment, a time of day, a day of a week, a season, a weather condition, an indication of darkness/light, etc.

In examples, the planning component 624 may determine a path for the vehicle 602 to follow to traverse through an environment. For example, the planning component 624 may determine various routes and trajectories and various levels of detail. For example, the planning component 624 may determine a route to travel from a first location (e.g., a current location) to a second location (e.g., a target location). For the purpose of this discussion, a route may be a sequence of waypoints for travelling between two locations. As non-limiting examples, waypoints include streets, intersections, GPS coordinates, etc. Further, the planning component 624 may generate an instruction for guiding the autonomous vehicle along at least a portion of the route from the first location to the second location. In at least one example, the planning component 624 may determine how to guide the autonomous vehicle from a first waypoint in the sequence of waypoints to a second waypoint in the sequence of waypoints. In some examples, the instruction may be a trajectory, or a portion of a trajectory. In some examples, multiple trajectories may be substantially simultaneously generated (e.g., within technical tolerances) in accordance with a receding horizon technique.

In examples, the planning component 624 may include a node selector 632 that is configured to determine which nodes of a tree structure to expand during trajectory planning. In examples, the planning component 624 may include a set of machine learning models 636 that may be executed to expand the selected nodes by determining predicted states resulting from simulation of different actions in different initial states. In examples, the planning component 624 may include an expansion component 634 that is configured to perform selective expansion of a decision tree based on nodes selected by the node selector 632 and predicted states generated by the machine learning models 636.

In at least one example, the one or more system controllers 626 may be configured to control steering, propulsion, braking, safety, emitters, communication, and other systems of the vehicle 602. The system controller(s) 626 may communicate with and/or control corresponding systems of the drive system(s) 614 and/or other components of the vehicle 602.

The memory 618 may further include the one or more maps 628 that may be used by the vehicle 602 to navigate within the environment. For example, a map may be any number of data structures modeled in two dimensions or three dimensions that are capable of providing information about an environment, such as, but not limited to, topologies (such as intersections), streets, mountain ranges, roads, terrain, and the environment in general. In one example, a map may include a three-dimensional mesh. In some instances, the map may be stored in a tiled format, such that individual tiles of the map represent a discrete portion of an environment, and may be loaded into working memory as needed. In some instances, the map(s) 628 may be divided into tiles by the vehicle computing device 604, by a computing device(s) 640, or by a combination of the two.

In some examples, the one or more maps 628 may be stored on a remote computing device(s) (such as the computing device(s) 640) accessible via network(s) 642. In some examples, multiple maps 628 may be stored based on, for example, a characteristic (e.g., type of entity, time of day, day of week, season of the year, etc.). Storing multiple maps 628 may have similar memory requirements, but increase the speed at which data in a heat map may be accessed.

In some instances, aspects of some or all of the components discussed herein may include any models, algorithms, and/or machine learning algorithms. For example, in some instances, the components in the memory 618 may be implemented as a neural network.

As described herein, an exemplary neural network passes input data through a series of connected layers to produce an output. Each layer in a neural network may also comprise another neural network, or may comprise any number of layers (whether convolutional or not). As may be understood in the context of this disclosure, a neural network may utilize machine learning, which may refer to a broad class of such algorithms in which an output is generated based on learned parameters.

Although discussed in the context of neural networks, any type of machine learning may be used consistent with this disclosure. For example, machine learning algorithms may include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like.

In at least one example, the sensor system(s) 606 may include lidar sensors, radar sensors, ultrasonic transducers, sonar sensors, location sensors (e.g., GPS, compass, etc.), inertial sensors (e.g., inertial measurement units (IMUs), accelerometers, magnetometers, gyroscopes, etc.), cameras (e.g., RGB, IR, intensity, depth, etc.), microphones, wheel encoders, environment sensors (e.g., temperature sensors, humidity sensors, light sensors, pressure sensors, etc.), etc. The sensor system(s) 606 may include multiple instances of each of these or other types of sensors. For instance, the lidar sensors may include individual lidar sensors located at the corners, front, back, sides, and/or top of the vehicle 602. As another example, the camera sensors may include multiple cameras disposed at various locations about the exterior and/or interior of the vehicle 602. The sensor system(s) 606 may provide input to the vehicle computing device 604. Additionally, and/or alternatively, the sensor system(s) 606 may send sensor data, via the one or more networks 642, to the one or more computing device(s) 640 at a particular frequency, after a lapse of a predetermined period of time, in near real-time, etc.

The vehicle 602 may also include the one or more emitters 608 for emitting light and/or sound, as described above. The emitters 608 in this example include interior audio and visual emitters to communicate with passengers of the vehicle 602. By way of example and not limitation, interior emitters may include speakers, lights, signs, display screens, touch screens, haptic emitters (e.g., vibration and/or force feedback), mechanical actuators (e.g., seatbelt tensioners, seat positioners, headrest positioners, etc.), and the like. The emitters 608 in this example also include exterior emitters. By way of example and not limitation, the exterior emitters in this example include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which may comprise acoustic beam steering technology.

The vehicle 602 may also include the one or more communication connection(s) 610 that enable communication between the vehicle 602 and one or more other local or remote computing device(s). For instance, the communication connection(s) 610 may facilitate communication with other local computing device(s) on the vehicle 602 and/or the drive system(s) 614. Also, the communication connection(s) 610 may allow the vehicle to communicate with other nearby computing device(s) (e.g., other nearby vehicles, traffic signals, etc.). The communication connection(s) 610 also enable the vehicle 602 to communicate with a remote teleoperations computing device or other remote services.

The communications connection(s) 610 may include physical and/or logical interfaces for connecting the vehicle computing device 604 to another computing device or a network, such as the network(s) 642. For example, the communications connection(s) 610 may enable Wi-Fi-based communication such as via frequencies defined by the IEEE 802.11 standards, short range wireless frequencies such as Bluetooth®, cellular communication (e.g., 2G, 3G, 4G, 4G LTE, 5G, etc.) or any suitable wired or wireless communications protocol that enables the respective computing device to interface with the other computing device(s).

In at least one example, the vehicle 602 may include the one or more drive systems 614. In some examples, the vehicle 602 may have a single drive system 614. In at least one example, if the vehicle 602 has multiple drive systems 614, individual drive systems 614 may be positioned on opposite ends of the vehicle 602 (e.g., the front and the rear, etc.). In at least one example, the drive system(s) 614 may include one or more sensor systems to detect conditions of the drive system(s) 614 and/or the surroundings of the vehicle 602. By way of example and not limitation, the sensor system(s) may include one or more wheel encoders (e.g., rotary encoders) to sense rotation of the wheels of the drive modules, inertial sensors (e.g., inertial measurement units, accelerometers, gyroscopes, magnetometers, etc.) to measure orientation and acceleration of the drive module, cameras or other image sensors, ultrasonic sensors to acoustically detect objects in the surroundings of the drive module, lidar sensors, radar sensors, etc. Some sensors, such as the wheel encoders may be unique to the drive system(s) 614. In some cases, the sensor system(s) on the drive system(s) 614 may overlap or supplement corresponding systems of the vehicle 602 (e.g., sensor system(s) 606).

The drive system(s) 614 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive system(s) 614 may include a drive module controller which may receive and preprocess data from the sensor system(s) and to control operation of the various vehicle systems. In some examples, the drive module controller may include one or more processors and memory communicatively coupled with the one or more processors. The memory may store one or more modules to perform various functionalities of the drive system(s) 614. Furthermore, the drive system(s) 614 also include one or more communication connection(s) that enable communication by the respective drive module with one or more other local or remote computing device(s).

In at least one example, the localization component 620, perception component 622, and/or the planning component 624 may process sensor data, as described above, and may send their respective outputs, over the one or more network(s) 642, to the one or more computing device(s) 640. In at least one example, the localization component 620, the perception component 622, and/or the planning component 624 may send their respective outputs to the one or more computing device(s) 640 at a particular frequency, after a lapse of a predetermined period of time, in near real-time, etc.

The vehicle 602 may send sensor data to the one or more computing device(s) 640, via the network(s) 642. In some examples, the vehicle 602 may send raw sensor data to the computing device(s) 640. In other examples, the vehicle 602 may send processed sensor data and/or representations of sensor data to the computing device(s) 640. In some examples, the vehicle 602 may send sensor data to the computing device(s) 640 at a particular frequency, after a lapse of a predetermined period of time, in near real-time, etc. In some cases, the vehicle 602 may send sensor data (raw or processed) to the computing device(s) 640 as one or more log files. The computing device(s) 640 may receive the sensor data (raw or processed) and may generate and/or update maps based on the sensor data.

In examples, the vehicle 602 may generate various log file(s) representing sensor data captured by the vehicle 602. For example, a log file may include, but is not limited to, sensor data captured by one or more sensors of the vehicle 602 (e.g., lidar sensors, radar sensors, sonar sensors, wheel encoders, inertial measurement units (IMUs) (which may include gyroscopes, magnetometers, accelerometers, etc.), GPS sensors, image sensors, and the like), route information, localization information, and the like. In some cases, a log file(s) may include a log of all sensor data captured by the vehicle 602, decisions made by the vehicle 602, determinations made regarding segmentation and/or classification, and the like. A log files(s) may be sent to and received by the computing device(s) 640.

In at least one example, the computing device(s) 640 may include one or more processors 644 and memory 646 communicatively coupled with the one or more processors 644. In the illustrated example, the memory 646 stores a training component 648 that may train the machine learning model 636 according to any of the techniques discussed herein. The training component 648 may train the machine learning model 636 at any time, such as while offline, and then send the machine learning model 636 to the vehicle 602 over the network(s) 642 to be implemented by the vehicle 602. In some cases, once trained, the machine learning model 636 is deployed on the vehicle computing device 604, and operations of the machine learning model 636 are performed by the vehicle computing device 604. In some cases, once trained, the machine learning model 636 is deployed on the computing device 640, operations of the machine learning model 636 are performed by the computing device 640 to generate model output data, and then model output data are transmitted to the perception component 622 of the vehicle computing device 604.

Although illustrated as being implemented on the computing device(s) 640, the training component 648 may be implemented on the vehicle 602, such as stored within the memory 618 of the vehicle computing device 604 and executed by the processor(s) 616 of the vehicle computing device 604. Further, any of the components of the vehicle computing device(s) 604 may alternatively, or additionally, be implemented by the computing device(s) 640.

The processor(s) 616 of the vehicle 602 and the processor(s) 644 of the computing device(s) 640 may be any suitable processor capable of executing instructions (e.g., computer-executable instructions) to process data and perform operations as described herein. By way of example and not limitation, the processor(s) 616 and 644 may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICS, etc.), gate arrays (e.g., FPGAs, etc.), and other hardware devices may also be considered processors in so far as they are configured to implement encoded instructions.

Memory 618 and memory 646 are examples of non-transitory computer-readable media. Memory 618 and memory 646 may store an operating system and one or more software applications, instructions, programs, and/or data to implement the methods described herein and the functions attributed to the various systems. In various implementations, the memory may be implemented using any suitable memory technology, such as static random access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

It should be noted that while FIG. 6 is illustrated as a distributed system, in alternative examples, components of the vehicle 602 may be associated with the computing device(s) 640 and/or components of the computing device(s) 640 may be associated with the vehicle 602. That is, the vehicle 602 may perform one or more of the functions associated with the computing device(s) 640, and vice versa.

### CONCLUSION

While one or more examples of the techniques described herein have been described, various alterations, additions, permutations and equivalents thereof are included within the scope of the techniques described herein. As can be understood, the components discussed herein are described as divided for illustrative purposes. However, the operations performed by the various components can be combined or performed in any other component. It should also be understood that components or steps discussed with respect to one example or implementation may be used in conjunction with components or steps of other examples. For example, the components and instructions of FIG. 6 may utilize the processes and flows of FIGS. 1-5.

A non-limiting list of objects may include obstacles in an environment, including but not limited to pedestrians, animals, cyclists, trucks, motorcycles, other vehicles, or the like. Such objects in the environment have a “geometric pose” (which may also be referred to herein as merely “pose”) comprising a location and/or orientation of the overall object relative to a frame of reference. In some examples, pose may be indicative of a position of an object (e.g., pedestrian), an orientation of the object, or relative appendage positions of the object. Geometric pose may be described in two-dimensions (e.g., using an x-y coordinate system) or three-dimensions (e.g., using an x-y-z or polar coordinate system), and may include an orientation (e.g., roll, pitch, and/or yaw) of the object. Some objects, such as pedestrians and animals, also have what is referred to herein as “appearance pose.” Appearance pose comprises a shape and/or positioning of parts of a body (e.g., appendages, head, torso, eyes, hands, feet, etc.). As used herein, the term “pose” refers to both the “geometric pose” of an object relative to a frame of reference and, in the case of pedestrians, animals, and other objects capable of changing shape and/or positioning of parts of a body, “appearance pose.” In some examples, the frame of reference is described with reference to a two- or three-dimensional coordinate system or map that describes the location of objects relative to a vehicle. However, in other examples, other frames of reference may be used.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

### Example Clauses

A: A system comprising: one or more processors; and one or more non-transitory computer-readable media storing computer-executable instructions that, when executed, cause the one or more processors to perform operations comprising: receiving a set of actions for controlling a vehicle through an environment; generating a tree structure by: creating a plurality of nodes associated with controlling the vehicle in accordance with an action of the set of actions over a period of time corresponding to a receding horizon; determining, for an intermediate node and based at least on a machine learned model, an estimated cost associated with a trajectory passing from a root node to the intermediate node; determining, based on the estimated cost, whether to expand the intermediate node; expanding a set of nodes that are deeper than the intermediate node to an end of the period of time; and determining whether to include a final node in the tree structure based at least in part on whether a corresponding trace reaches a termination state; determining, based at least in part on the tree structure, a trace through the tree structure having a lowest cost, the trace associated with an optimal trajectory; and controlling the vehicle based at least in part on the optimal trajectory.

B: The system of paragraph A, wherein the intermediate node is associated with a set of layers of the tree structure that excludes a first layer and a final layer of tree structure.

C: The system of paragraph A or B, wherein the intermediate node is expanded based on the estimated cost and a known cost associated with reaching a state corresponding to the intermediate node, and wherein the known cost is determined based on at least one of: a safety cost associated with reaching the state, a comfort cost associated with reaching the state, or a measure determined based on compliance of an action associated with the state with a policy.

D: The system of any of paragraphs A-C, wherein the set of actions comprises at least one of: slowing the vehicle down, turning the vehicle to left, turning the vehicle to right, or speeding the vehicle up.

E: The system of any of paragraphs A-D, the operations comprising: expanding the intermediate node and refraining from expanding a second intermediate node based at least in part on determining that the estimated cost associated with the intermediate node exceeds a second estimated cost associated with the second intermediate node.

F: A method comprising: creating a plurality of nodes associated with a tree structure for controlling a vehicle, the tree structure comprising a root node and an intermediate node; determining, for the intermediate node and based at least on a machine learned model, an estimated cost associated with a trajectory passing from the root node to the intermediate node; determining, based on the estimated cost, whether to expand the intermediate node; expanding a set of nodes that are deeper than the intermediate node to an end of a period of time; determining, based at least in part on the tree structure, a trace through the tree structure having a lowest cost; and controlling the vehicle based at least in part on the trace.

G: The method of paragraph F, further comprising: expanding a node of the tree structure that is deeper in the tree structure than the intermediate node until the end of the period of time.

H: The method of paragraph F or G, comprising: refraining from expanding a node of the tree structure that is deeper than the intermediate node in the tree structure based on determining that a corresponding trace fails to reach a termination state.

I: The method of any of paragraphs F-H, wherein a first number of intermediate node layers is determined based on at least one of: at least two less than a total number of layers associated with the tree structure, or an amount of available computational resources at a time associated with generating the tree structure.

J: The method of any of paragraphs F-I, further comprising: determining a lower bound for the estimated cost based on a cost associated with reaching the intermediate node; and determining an upper bound for the estimated cost based on a deviation between a path comprising the intermediate node and a maximum-cost path.

K: The method of paragraph J, wherein determining the tree structure comprises: expanding a node of the tree structure with a respective tree depth value that falls below a threshold range.

L: The method of paragraph J or K, wherein determining the tree structure comprises: expanding a node of the tree structure that is associated with a predefined action sequence.

M: The method of any of paragraphs F-L, wherein the estimated cost is determined based on at least one of: environment state data representing a state characteristic of an environment of the vehicle at a first predicted state associated with the intermediate node; or object data representing a characteristic of at least one of a dynamic object or the vehicle at the first predicted state.

N: One or more non-transitory computer-readable media storing instructions executable by one or more processors, wherein the instructions, when executed, cause the one or more processors to perform operations comprising: creating a plurality of nodes associated with a tree structure for controlling a vehicle, the tree structure comprising a root node and an intermediate node; determining, for the intermediate node and based at least on a machine learned model, an estimated cost associated with a trajectory passing from the root node to the intermediate node; determining, based on the estimated cost, whether to expand the intermediate node; expanding a set of nodes that are deeper than the intermediate node to an end of a period of time; determining, based at least in part on the tree structure, a trace through the tree structure having a lowest cost; and controlling the vehicle based at least in part on the trace.

O: The one or more non-transitory computer-readable media of paragraph N, the operations further comprising: expanding a node of the tree structure that is deeper in the tree structure than the intermediate node until the end of the period of time.

P: The one or more non-transitory computer-readable media of paragraph N or O, the operations further comprising: refraining from expanding a node of the tree structure that is deeper than the intermediate node in the tree structure based on determining that a corresponding trace fails to reach a termination state.

Q: The one or more non-transitory computer-readable media of any of paragraphs N-P, wherein a first number of intermediate node layers is determined based on at least one of: at least two less than a total number of layers associated with the tree structure, or an amount of available computational resources at a time associated with generating the tree structure.

R: The one or more non-transitory computer-readable media of any of paragraphs N-Q, wherein: determining a lower bound for the estimated cost based on a cost associated with reaching the intermediate node; and determining an upper bound for the estimated cost based on a deviation between a path comprising the intermediate node and a maximum-cost path.

S: The one or more non-transitory computer-readable media of paragraph R, wherein determining the tree structure comprises: expanding a node of the tree structure with a respective tree depth value that falls below a threshold range.

T: The one or more non-transitory computer-readable media of paragraph R or S, wherein determining the tree structure comprises: expanding a node of the tree structure that is associated with a predefined action sequence.

While the example clauses described above are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

What is claimed is:

1. A system comprising:
one or more processors; and
one or more non-transitory computer-readable media storing computer-executable instructions that, when executed, cause the one or more processors to perform operations comprising:
receiving a set of actions for controlling a vehicle through an environment;
generating a tree structure by:
creating a plurality of nodes associated with controlling the vehicle in accordance with an action of the set of actions over a period of time corresponding to a receding horizon;
determining, for an intermediate node and based at least on a machine learned model, an estimated cost associated with a trajectory passing from a root node to the intermediate node;
determining, based on the estimated cost, whether to expand the intermediate node;
expanding a set of nodes that are deeper than the intermediate node to an end of the period of time; and
determining whether to include a final node in the tree structure based at least in part on whether a corresponding trace reaches a termination state;
determining, based at least in part on the tree structure, a trace through the tree structure having a lowest cost, the trace associated with an optimal trajectory; and
controlling the vehicle based at least in part on the optimal trajectory.

2. The system of claim 1, wherein the intermediate node is associated with a set of layers of the tree structure that excludes a first layer and a final layer of tree structure.

3. The system of claim 1, wherein the intermediate node is expanded based on the estimated cost and a known cost associated with reaching a state corresponding to the intermediate node, and wherein the known cost is determined based on at least one of:
a safety cost associated with reaching the state,
a comfort cost associated with reaching the state, or
a measure determined based on compliance of an action associated with the state with a policy.

4. The system of claim 1, wherein the set of actions comprises at least one of:
slowing the vehicle down,
turning the vehicle to left,
turning the vehicle to right, or
speeding the vehicle up.

5. The system of claim 1, the operations comprising:
expanding the intermediate node and refraining from expanding a second intermediate node based at least in part on determining that the estimated cost associated with the intermediate node exceeds a second estimated cost associated with the second intermediate node.

6. A method comprising:
creating a plurality of nodes associated with a tree structure for controlling a vehicle, the tree structure comprising a root node and an intermediate node;
determining, for the intermediate node and based at least on a machine learned model, an estimated cost associated with a trajectory passing from the root node to the intermediate node;
determining, based on the estimated cost, whether to expand the intermediate node;
expanding a set of nodes that are deeper than the intermediate node to an end of a period of time;
determining, based at least in part on the tree structure, a trace through the tree structure having a lowest cost; and
controlling the vehicle based at least in part on the trace.

7. The method of claim 6, further comprising:
expanding a node of the tree structure that is deeper in the tree structure than the intermediate node until the end of the period of time.

8. The method of claim 6, comprising:
refraining from expanding a node of the tree structure that is deeper than the intermediate node in the tree structure based on determining that a corresponding trace fails to reach a termination state.

9. The method of claim 6, wherein a first number of intermediate node layers is determined based on at least one of:
at least two less than a total number of layers associated with the tree structure, or
an amount of available computational resources at a time associated with generating the tree structure.

10. The method of claim 6, further comprising:
determining a lower bound for the estimated cost based on a cost associated with reaching the intermediate node; and
determining an upper bound for the estimated cost based on a deviation between a path comprising the intermediate node and a maximum-cost path.

11. The method of claim 10, wherein determining the tree structure comprises:
expanding a node of the tree structure with a respective tree depth value that falls below a threshold range.

12. The method of claim 10, wherein determining the tree structure comprises:
expanding a node of the tree structure that is associated with a predefined action sequence.

13. The method of claim 6, wherein the estimated cost is determined based on at least one of:
environment state data representing a state characteristic of an environment of the vehicle at a first predicted state associated with the intermediate node; or
object data representing a characteristic of at least one of a dynamic object or the vehicle at the first predicted state.

14. One or more non-transitory computer-readable media storing instructions executable by one or more processors, wherein the instructions, when executed, cause the one or more processors to perform operations comprising:
creating a plurality of nodes associated with a tree structure for controlling a vehicle, the tree structure comprising a root node and an intermediate node;
determining, for the intermediate node and based at least on a machine learned model, an estimated cost associated with a trajectory passing from the root node to the intermediate node;
determining, based on the estimated cost, whether to expand the intermediate node;
expanding a set of nodes that are deeper than the intermediate node to an end of a period of time;
determining, based at least in part on the tree structure, a trace through the tree structure having a lowest cost; and
controlling the vehicle based at least in part on the trace.

15. The one or more non-transitory computer-readable media of claim 14, the operations further comprising:
expanding a node of the tree structure that is deeper in the tree structure than the intermediate node until the end of the period of time.

16. The one or more non-transitory computer-readable media of claim 14, the operations further comprising:
refraining from expanding a node of the tree structure that is deeper than the intermediate node in the tree structure based on determining that a corresponding trace fails to reach a termination state.

17. The one or more non-transitory computer-readable media of claim 14, wherein a first number of intermediate node layers is determined based on at least one of:
at least two less than a total number of layers associated with the tree structure, or
an amount of available computational resources at a time associated with generating the tree structure.

18. The one or more non-transitory computer-readable media of claim 14, wherein:
determining a lower bound for the estimated cost based on a cost associated with reaching the intermediate node; and
determining an upper bound for the estimated cost based on a deviation between a path comprising the intermediate node and a maximum-cost path.

19. The one or more non-transitory computer-readable media of claim 18, wherein determining the tree structure comprises:
expanding a node of the tree structure with a respective tree depth value that falls below a threshold range.

20. The one or more non-transitory computer-readable media of claim 18, wherein determining the tree structure comprises:
expanding a node of the tree structure that is associated with a predefined action sequence.
